(19) United States
(12) Patent Application Publication
(10) Pub. No.: US 2012/0307537 A1
(43) Pub. Date: Dec. 6, 2012

(54) RECTIFIER CIRCUIT, METHOD FOR OPERATING THE RECTIFIER CIRCUIT, AND ENERGY HARVESTING SYSTEM COMPRISING THE RECTIFIER CIRCUIT

(75) Inventors: Stefano Ramorini, Arluno (IT); Alessandro Gasparini, Cusano Milanino (IT); Giorgio Massimiliano Membretti, Milano (IT)

(73) Assignee: STMICROELECTRONICS S.R.L., Agrate Brianza (MB) (IT)

(21) Appl. No.: 13/482,069

(22) Filed: May 29, 2012

(30) Foreign Application Priority Data
May 30, 2011 (IT) TO2011A000470

(51) Int. Cl. H02M 7/06

(52) U.S. Cl. 363/126

(57) ABSTRACT

The input terminals of an energy-scavenging interface are connectable to a transducer including a storage element, and output terminals of the interface are connectable to an electrical load. The interface includes a first switch that is closed to pass current and store electrical energy in the storage element for a first time interval. The first time interval is based on at least one of a first delay proportional to a time constant of the transducer and sensed current flowing through the first switch reaching a first threshold. The first switch is thereafter opened so to permit the stored electrical energy to be delivered through a first current-conduction element for a second time interval. The second time interval is based on sensed current flowing through the first current-conduction element reaching a second threshold. The first current-conduction element may comprise a second switch actuate out of phase with the first switch.

### PRIORITY CLAIM

This application claims priority from Italian Application for Patent No. TO2011A000470 filed May 30, 2011, the disclosure of which is hereby incorporated by reference.

### TECHNICAL FIELD

The present invention relates to a rectifier circuit, to a method for operating the rectifier circuit, and to an environmental-energy harvesting system comprising the rectifier circuit. The present invention moreover relates to an apparatus (for example, a vehicle) comprising the environmental-energy harvesting system.

### BACKGROUND

As is known, systems for harvesting energy (also known as “energy harvesting systems” or “energy-scavenging systems”) from intermittent environmental energy sources (i.e., sources that supply energy in an irregular way) have aroused and continue to arouse considerable interest in a wide range of technological fields. Typically, energy harvesting systems are adapted to harvest, store, and transfer energy generated by mechanical sources to a generic load of an electrical type.

Low-frequency vibrations, such as for example mechanical vibrations of disturbance in systems with moving parts, can be a valid source of energy. Mechanical energy is converted, by one or more appropriate transducers (for example, piezoelectric or electromagnetic devices) into electrical energy, which can be used for supplying an electrical load. In this way, the electrical load does not require batteries or other supply systems that are cumbersome and poorly resistant to mechanical stresses.

FIG. 1 is a schematic illustration, by means of functional blocks, of an energy harvesting system of a known type.

The energy harvesting system 1 of FIG. 1 comprises: a transducer 2, for example of an electromagnetic type, which is adapted to convert the mechanical energy of environmental mechanical vibrations into electrical energy, typically into AC voltages; a scavenging interface 4, for example comprising a diode-bridge rectifier circuit (also known as Graetz bridge), configured for receiving at input the AC signal generated by the transducer 2 and supplying at output a DC signal for charging a capacitor 5 connected to the output of the rectifier circuit 4; and a DC-DC converter 6, connected to the capacitor 5 for receiving at input the electrical energy stored by the capacitor 5 and supplying it to an electrical load 8. The capacitor 5 hence has the function of energy-storage element, energy which is made available, when required, to the electrical load 8 for operation of the latter.

The global efficiency η_{TOT} of the energy harvesting system 1 is given by Eq. (1) below

η_{NOT}=η_{TRANSD}·η_{SCAV}·η_{DCDC} (1)

where: ηTRANSD is the efficiency of the transducer 2, indicating the amount of power available in the environment that has been effectively converted, by the transducer 2, into electrical power; η_{SCAV} is the efficiency of the scavenging interface 4, indicating the power dissipated by the scavenging interface 4 and the factor of impedance coupling η_{COUPLE} between the transducer 2 and the scavenging interface; and η_{DCDC} is the efficiency of the DC-DC converter 6.

As is known, in order to supply to the load the maximum power available, the impedance of the load should be equal to that of the source. As illustrated in FIG. 2, the transducer 2 can be represented schematically, in this context, as a voltage generator 3 provided with a resistance R_{S} of its own. The maximum power P_{TRANSD}^{MAX} that the transducer 2 can supply at output may be defined as:

P_{TRANSD}^{MAX}=V_{TRANSD}²/4R_{S} if R_{LOAD}=R_{S} (2)

where: V_{TRANSD} is the voltage produced by the equivalent voltage generator; and R_{LOAD} is the equivalent electrical resistance at the output of the transducer 2 (or, likewise, seen at input to the scavenging interface 4), which takes into due consideration the equivalent resistance of the scavenging interface 4, of the DC-DC converter 6, and of the load 8.

Due to the impedance mismatch (R_{LOAD}≠R_{S}), the power at input to the scavenging interface 4 is lower than the maximum power available P_{TRANSD}^{MAX}.

The power P_{SCAV} transferred to the capacitor 5 is a fraction of the power recovered by the interface, and is given by Eq. (3) below

P_{SCAV}=η_{TRANSD}·η_{SCAV}·P_{TRANSD}^{MAX} (3)

The power required of the DC-DC converter 6 for supplying the electrical load 8 is given by the following Eq. (4)

P_{LOAD}=P_{DCDC}·η_{DCDC} (4)

where _{PDCDC} is the power received at input by the DC-DC converter 8, in this case coinciding with P_{SCAV}, and P_{LOAD} is the power required by the electrical load.

The efficiency of the system 1 of FIG. 1 markedly depends upon the signal generated by the transducer 2.

The efficiency drops rapidly to the zero value (i.e., the system 1 is unable to harvest environmental energy) if the amplitude of the signal of the transducer (signal V_{TRANSD}) assumes a value lower, in absolute value, than V_{OUT}+2V_{TH}_{_{—}}_{D}, where V_{OUT} is the voltage accumulated on the capacitor 5 and V_{TH}_{_{—}}_{D} is the threshold voltage of the diodes that form the scavenging interface 4. As a consequence of this, the maximum energy that can be stored in the capacitor 5 is limited to the value Eₘₐₓ=0.5·C_{OUT}(V_{TRANSD}^{MAX}−2V_{TH}_{_{—}}_{D})². If the amplitude of the signal V_{TRANSD} of the transducer 2 is lower than twice the threshold voltage V_{TH}_{_{—}}_{D} of the diodes of the rectifier of the scavenging interface 4 (i.e., V_{TRANSD}<2V_{TH}_{_{—}}_{D}), energy is not harvested from the environment and the load is not supplied.

### SUMMARY

One aim of the present invention is to provide a rectifier circuit, a method for operating the rectifier circuit, an environmental-energy harvesting system comprising the rectifier circuit, and an apparatus comprising the environmental-energy harvesting system that will enable the aforesaid problems and disadvantages to be overcome, and in particular that will present a high efficiency.

Accordingly, a rectifier circuit, a method for operating the rectifier circuit, an environmental-energy harvesting system comprising the rectifier circuit, and an apparatus comprising the environmental-energy harvesting system, are consequently provided as defined in the annexed claims.

The energy-scavenging interface (which, in particular, has the configuration of a rectifier circuit) can be connected between an input signal source (in particular, an AC voltage signal) and an electrical load to be supplied (possibly by means of interposition of a DC-DC converter for supplying the load with an adequate voltage level). The energy-scavenging interface comprises a first switch and a second switch, each having a control terminal, connected between the input and the output terminals of the energy-scavenging interface. In particular, the first switch is connected between the first input terminal of the energy-scavenging interface and an output terminal at reference voltage, whilst the second switch is connected between the second input terminal of the energy-scavenging interface and the output terminal at reference voltage.

The energy-scavenging interface further comprises control logic, coupled to the control terminals of the first and second switches, configured for opening/closing the first and second switches by means of an appropriate control signal.

In one embodiment, the energy-scavenging interface further comprises a first diode and a second diode, one of which is connected between the first input terminal and a further output terminal of the energy-scavenging interface, and the other is connected between the second input terminal and the further output terminal of the energy-scavenging interface.

According to a different embodiment, the first and second diodes are replaced by a respective third switch and fourth switch, each having a control terminal. In this case, the control logic is moreover configured for operating third and fourth switches for generating, at output from the energy-scavenging interface, a substantially DC signal.

The first, second, third, and fourth switches are, for example, n-channel MOSFETs having an internal diode (parasitic diode). In this case, the third and fourth switches can be operated in an active way (by actively controlling turning-on and turning-off of the MOSFETs), or in a passive way (by turning off the MOSFETs and exploiting the internal parasitic diode). Alternatively, the second, third, and fourth switches are obtained with a different technology; for example, they can be p-channel MOSFETs, or NPN or PNP bipolar transistors, IGBTs, or the like.

Present on the output of the energy-scavenging interface is a capacitor adapted to store the power transferred at output by the scavenging interface. In parallel to the capacitor there may be present an electrical load, which is supplied by means of the energy accumulated in the capacitor. As has already been said, between the capacitor and the electrical load there can be set a DC-DC converter, of a buck, or boost, or buck/boost type.

The energy-scavenging interface is described in detail with reference to a preferred application thereof, in particular as rectifier circuit of an energy harvesting system set between an AC voltage source and a storage element and/or electrical load.

### BRIEF DESCRIPTION OF THE DRAWINGS

For a better understanding of the present invention, preferred embodiments thereof are now described, purely by way of non-limiting example and with reference to the attached drawings, wherein:

FIG. 1 shows an energy harvesting system according to a known embodiment;

FIG. 2 shows an energy harvesting system according to a further known embodiment;

FIG. 3 shows an energy harvesting system comprising an energy-scavenging interface that can be operated according to the steps of the method of FIG. 8, according to one embodiment;

FIGS. 4a and 4b show the energy harvesting system of FIG. 3 in respective successive operating conditions;

FIGS. 5a-5c show the time plots of current signals of the energy harvesting system of FIG. 3 in the operating conditions of FIGS. 4a and 4b;

FIGS. 6a and 6b show values of optimal duration in which the system of FIG. 3 remains in the operating state of FIG. 4 as a function, respectively, of the output voltage and the voltage of the transducer;

FIG. 7 shows the energy harvesting system of FIG. 3, further comprising control means for operating the energy harvesting system according to the steps of the method of FIG. 8, according to one embodiment;

FIG. 8 shows, by means of a flowchart, steps of a method for control of the energy harvesting system of FIG. 3, according to one embodiment;

FIG. 9 shows the energy harvesting system of FIG. 7 comprising control means for operating the energy harvesting system according to the steps of the method of FIG. 10, according to a further embodiment;

FIG. 10 shows, by means of a flowchart, steps of a method for control of the energy harvesting system of FIG. 9, according to a further embodiment; and

FIG. 11 shows a vehicle comprising the energy harvesting system of FIG. 7 or FIG. 9.

### DETAILED DESCRIPTION OF THE DRAWINGS

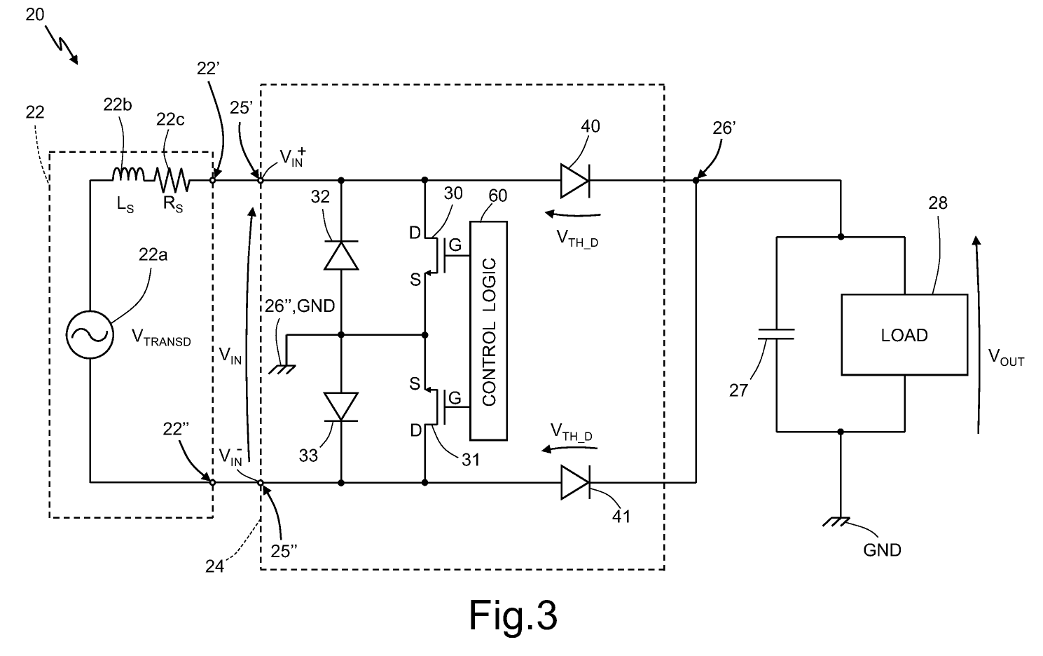

FIG. 3 shows an energy harvesting system 20 comprising a rectifier circuit 24 (which, as has been said, has the function of an energy-scavenging interface).

In general, the energy harvesting system 20 comprises: a transducer 22 including output terminals 22′, 22″ of its own; the rectifier circuit 24, including a first input terminal 25′ and a second input terminal 25″, which are electrically coupled, respectively, to the output terminals 22′, 22″ of the transducer 22, and a first output terminal 26′ and a second output terminal 26″; and a storage element 27, for example a capacitor, which is connected between the first output terminal 26′ and a reference node (which may comprise the second output terminal 26″), and is configured for storing electrical charge supplied at output by the rectifier circuit 24.

According to one embodiment, the reference node and second output terminal 26″ is a terminal at reference voltage, for example at ground voltage GND, for example at approximately 0 V. Other reference voltages can be used.

The transducer 22 is, for example, an electromagnetic transducer, and is illustrated schematically, in FIG. 3, in a way similar to the one already shown in FIG. 2, including an equivalent voltage generator 22a, adapted to supply a voltage V_{TRANSD}, an inductor 22b (the inductor that forms the electromagnetic transducer), having a value of inductance L_{S}, and a resistor 22c, having a value of resistance R_{S}, connected in series to the inductor 22b.

On the output of the rectifier circuit 24, in parallel to the storage element 27, there can be connected an electrical load 28, adapted to be supplied by the charge stored in the storage element 27, or a DC-DC converter in the case where the electrical load requires a voltage value different from the one generated at output by the rectifier circuit 24.

Connected between the first input terminal 25′ and the second output terminal 26″ of the rectifier circuit 24 is a first switch 30, in particular of a voltage-controlled type. The first switch 30 is, for example, an n-type MOSFET. Connected between the second input terminal 25″ and the second output terminal 26″ is a second switch 31, in particular of a voltage-controlled type. Also the second switch 31 is, for example, an n-type MOSFET.

For simplicity of description in what follows the first and second switches 30, 31 will be referred to, respectively, as first and second transistors 30, 31, without this implying any loss of generality. Likewise, by the term “transistor closed” is meant in what follows a transistor biased in such a way as to enable conduction of electric current between its source and drain terminals, i.e., configured for behaving as a closed switch, and by the term “transistor open” is meant in what follows a transistor biased in such a way as to not enable conduction of electric current between its source and drain terminals, i.e., configured for behaving as an open switch.

Represented between the source terminal S and the drain terminal D of the first transistor 30, is a first diode 32, in configuration known as “antiparallel configuration” (with respect to the normal direction of flow of the current through the first transistor 30). As is known, a characteristic of a MOSFET is that of displaying, under certain operating conditions, the electrical properties of a diode (parasitic diode). Said diode is electrically set (integrated) between the source and drain terminals of the MOSFET. In other words, the first transistor 30 can present the electrical behavior of a diode, where the cathode of the diode corresponds to the drain terminal and the anode to the source terminal of the first transistor 30 (vice versa in the case of p-type MOSFETs). The first diode 32 is hence the diode integrated in the first transistor 30.

Likewise, a second diode 33 is represented connected in antiparallel configuration between the source terminal S and the drain terminal D of the second transistor 31; also in this case, the second diode 33 is the diode integrated in the second transistor 31.

In greater detail, the drain terminal D of the first transistor 30 is connected to the first input terminal 25′ of the rectifier circuit 24, and the source terminal S of the first transistor 30 is connected to the second output terminal 26″. The drain terminal D of the second transistor 31 is connected to the second input terminal 25″ of the rectifier circuit 24, and the source terminal S of the second transistor 31 is connected to the second output terminal 26″.

The rectifier circuit 24 further comprises a third diode 40 and a fourth diode 41. The third diode 40 has the anode terminal connected to the first input terminal 25′ and the cathode terminal connected to the first output terminal 26′ of the rectifier circuit 24. The fourth diode 41 has the anode terminal connected to the second input terminal 25″ and the cathode terminal connected to the first output terminal 26′ of the rectifier circuit 24.

During the positive half-cycles of the voltage of the transducer V_{TRANSD}, voltage rectification is carried out by means of the first transistor 30 and the third diode 40; instead, during the negative half-cycles of the voltage of the transducer V_{TRANSD}, voltage rectification is carried out by means of the second transistor 31 and the fourth diode 41.

In particular, in the positive half-cycles of the voltage V_{TRANSD} of the transducer 22, a control logic 60 keeps the second transistor 31 open and opens/closes the first transistor 30 according to a control method described in detail in what follows. Said control method envisages that the first transistor 30 will be kept closed until a given time interval (T_{DELAY}) has elapsed and a minimum threshold value I_{TH} of the current that flows in the inductor 22b has been reached. When both of these conditions are met, the control logic 60 opens the first transistor 30, and the energy accumulated in the inductor 22b is transferred onto the capacitor 27 through the third diode 40. When the current in the inductor 22b goes to zero, the control logic 60 closes the first transistor 30 again, and the steps described start again in a cyclic way.

Likewise, for negative polarities of the signal V_{TRANSD} of the transducer 22, the first transistor 30 is kept closed whilst the second transistor 31 is opened/closed in a way similar to what has been described previously with reference to the first transistor 30. In this case, the energy accumulated in the inductor 22b is transferred onto the capacitor 27 through the fourth diode 41.

As has been said, the steps described for operating the first transistor 30 for positive values of polarity of the input signal V_{IN} are similar to the steps for operating the second transistor 31 for negative values of polarity of the input signal V_{IN}. Likewise, the circuit structure of the rectifier 24 is symmetrical.

In what follows, operation of the rectifier 24 will be described more fully with reference to a circuit model that applies to one polarity (in particular just the positive polarity) of the input signal V_{IN}, but can be readily applied, in a symmetrical way, to operation for negative polarities of the input signal V_{IN}.

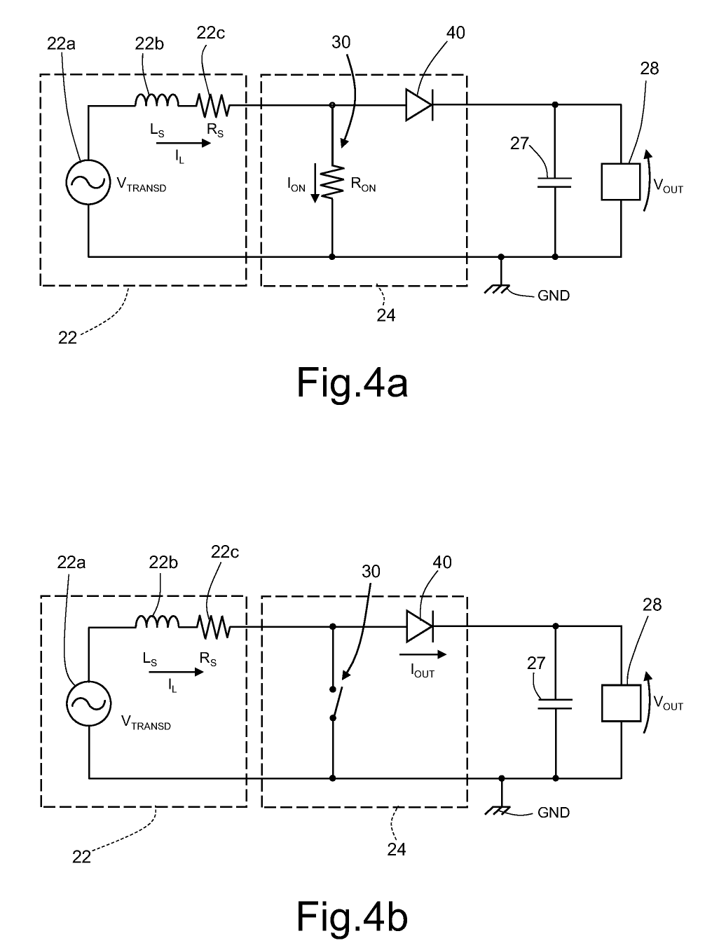

FIG. 4a shows a circuit equivalent to the circuit of FIG. 3 in which the second transistor 31 is closed, and is consequently replaced by an (ideal) short circuit.

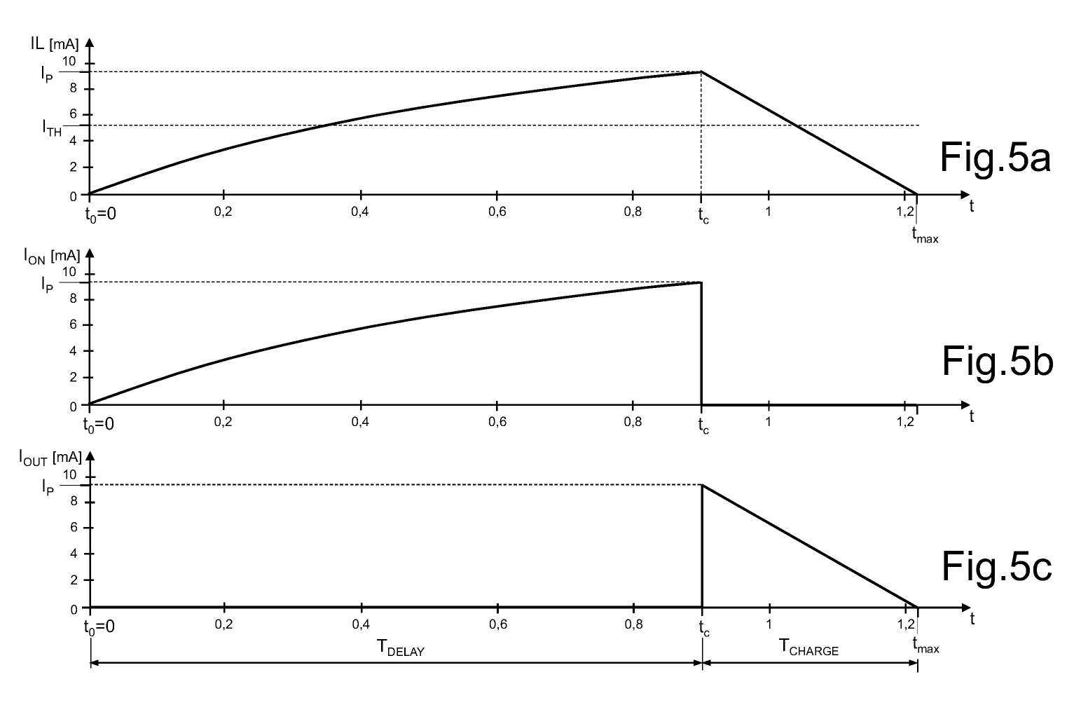

In this situation, the first transistor 30 presents an on-state resistance equal to R_{ON}. The current I_{L} that flows in the inductor 22b is equal to the current I_{ON} that flows through the on-state resistance R_{ON} of the first transistor 30. The value of the current I_{L} grows in a way proportional to the value of the constant L_{S}/R_{S}, until it reaches a steady-state value I_{P}≈V_{TRANSD}/R_{S} (see the graph of FIG. 5a).

Once the time interval T_{DELAY} has elapsed, and assuming that the current I_{L} that flows in the inductor 22b has reached a value equal to, or higher than, the threshold value I_{TH}, control passes to the operating condition illustrated schematically in FIG. 4b.

The time interval T_{DELAY} is the interval elapsing between the instant of closing of the first transistor 30 (t₀) and the instant of opening of the first transistor 30 (t_{c}). The threshold current value I_{TH} is chosen on the basis of the current peak values Iₚ that are reached according to the application of the rectifier circuit 24. These values depend upon the characteristics of the transducer 22 and upon the environmental stresses to which the transducer 22 is subjected. In particular, the threshold current value I_{TH} is chosen much smaller than the peak value Iₚ that is expected to be reached in the application in which the rectifier circuit 24 is used. For example, if we assume that peak values Iₚ of approximately 150 mA are to be reached, the threshold I_{TH} can be chosen between approximately 5 mA and 10 mA.

With reference to FIG. 4b, at time t, the first transistor 30 is opened and the current I_{L} that flows in the inductor 22b is the current I_{OUT} supplied at output by the rectifier 24. The current in the inductor 22b decreases with a constant slope, until it reaches the zero value (at time tₘₐₓ, see again FIG. 5a), according to the relation:

$$\frac{d {I}_{L}}{d t} = \frac{{V}_{OUT} + {V}_{BE} - {V}_{TRANSD}}{{L}_{S}}$$

where V_{BE} is the direct voltage drop across the third diode 40.

FIG. 5a shows the plot of the current I_{L} in time t. The curve of the current I_{L} reaches the maximum value Iₚ at instant t, in which the first transistor 30 is opened (see FIG. 5b). The current I_{L} in the time interval t₀-t_{c} (interval T_{DELAY}; it is assumed, for simplicity, that t₀=0 s) grows according to the following relation:

$$\frac{{V}_{TRANSD}}{{R}_{S}} ( 1 - {e}^{- \frac{t}{{τ}_{TRANSD}}} )$$

where τ_{TRANSD} is the time constant of the transducer 22, given by τ_{TRANSD}=L_{S}/R_{S}. The time constant of a transducer is, typically, defined as the time necessary in order for the output of the transducer to reach a percentage value (e.g., 63%) of the final value, in the case where the input of the transducer undergoes a sharp variation (step signal).

Then, between t_{c} and tₘₐₓ (time interval T_{CHARGE}) the current I_{L} decreases until it reaches the value I_{L}=0 A.

FIG. 5b shows, using the same time scale as that of FIG. 5a, the plot of the current I_{ON} that flows through the first transistor 30.

In the time interval t₀-t_{c} the current I_{ON} coincides with the current I_{L} (we are, in fact, in the situation of FIG. 4a); at instant t_{c}, the first transistor 30 is opened (FIG. 5b) and the current I_{ON} drops to zero.

FIG. 5c shows, using the same time scale as that of FIGS. 5a and 5b, the plot of the output current I_{OUT}. The current I_{OUT} remains at a zero value during the time interval t₀-t_{c}, and then increases to the value I_{P} at instant t_{c} (upon opening of the first transistor 30). Then, between t_{c} and tₘₐₓ (time interval T_{CHARGE}), the output current I_{OUT} coincides with the current I_{L}.

The time interval T_{CHARGE} is given by:

$${T}_{CHARGE} = {L}_{S} \frac{{I}_{P}}{{V}_{OUT} + {V}_{TH\_D} + {V}_{S}}$$

where V_{TH}_{_{—}}_{D} is the threshold voltage of the third diode 40.

At time tₘₐₓ, the first transistor 30 is again closed, and the inductor 22b is charged, according to what has already been described. The steps of charging and discharging of the inductor 22b (and, consequently, of supply of the capacitor 27/load 28) are repeated in a cyclic way.

The integral of the curve of I_{OUT} (FIG. 5c) between time t_{c} and time tₘₐₓ indicates the charge Q_{CYCLE} transferred between the input and the output of the rectifier 24 in time T_{CHARGE}. In order to maximize the efficiency of transfer of charge between the input and the output of the rectifier 24, it is expedient to maximize the value of the power P_{CYCLE} transferred at output at each cycle of charge/discharge of the inductor 22b. The power P_{CYCLE} is defined as P_{CYCLE}=V_{OUT}·I_{CYCLE}, where I_{CYCLE} is given by I_{CYCLE}=Q_{CYCLE}/T_{CYCLE}, where T_{CYCLE} is the time interval elapsing between t₀ and tₘₐₓ (T_{CYCLE}=T_{DELAY}+T_{CHARGE}).

The present applicant has found that the value of P_{CYCLE} is given by the following formula:

$${P}_{CYCLE} = \frac{{L}_{S} \cdot {[ \frac{{V}_{TRANSD}}{{R}_{S}} \cdot ( 1 - {e}^{- \frac{{τ}_{DELAY}}{{τ}_{TRANSD}}} ) ]}^{2}}{2 \cdot ( {V}_{OUT} - {V}_{TRANSD} ) \cdot [ {T}_{DELAY} + \frac{\begin{matrix}{T}_{DELAY} \cdot \\ {V}_{TRANSD} \cdot \\ ( 1 - {e}^{- \frac{{τ}_{DELAY}}{{τ}_{TRANSD}}} )\end{matrix}}{{V}_{OUT} - {V}_{TRANSD}} ] \cdot {V}_{OUT}}$$

The optimization of the value of P_{CYCLE} enables an optimal value of the time interval T_{DELAY} to be obtained as a function of the value of V_{TRANSD} and V_{OUT}. However, the present applicant has found that the dependence of T_{DELAY} upon V_{TRANSD} and V_{OUT} is negligible for practical purposes, and T_{DELAY} is chosen proportional to T_{TRANSD}, for example comprised between approximately 1·τ_{TRANSD} and approximately 2 τ_{TRANSD}, in particular approximately 1.5·τ_{TRANSD}. In the particular case considered, the time constant τ_{TRANSD} of the transducer 2 is, as has already been said previously, equal to L_{S}/R_{S}. However, for other types of transducer, the time constant τ_{TRANSD} can be defined in a different way.

The value of T_{DELAY} chosen is an optimal value irrespective of the value assumed by V_{TRANSD} and V_{OUT}. This enables a value of coupling efficiency η_{COUPLE} to be obtained that is particularly high, and substantially independent of the voltage V_{TRANSD} developed by the transducer 2 and of the voltage accumulated at output V_{OUT}.

The coupling efficiency η_{COUPLE} is given by P_{CYCLE}^{OPT}/P_{TRANSD}^{MAX}, where P_{CYCLE}^{OPT} is the value of P_{CYCLE} calculated as T_{DELAY}=1.5·L_{S}/R_{S}, and P_{TRANSD}^{MAX} is given by (V_{TRANSD})²/4R_{S}.

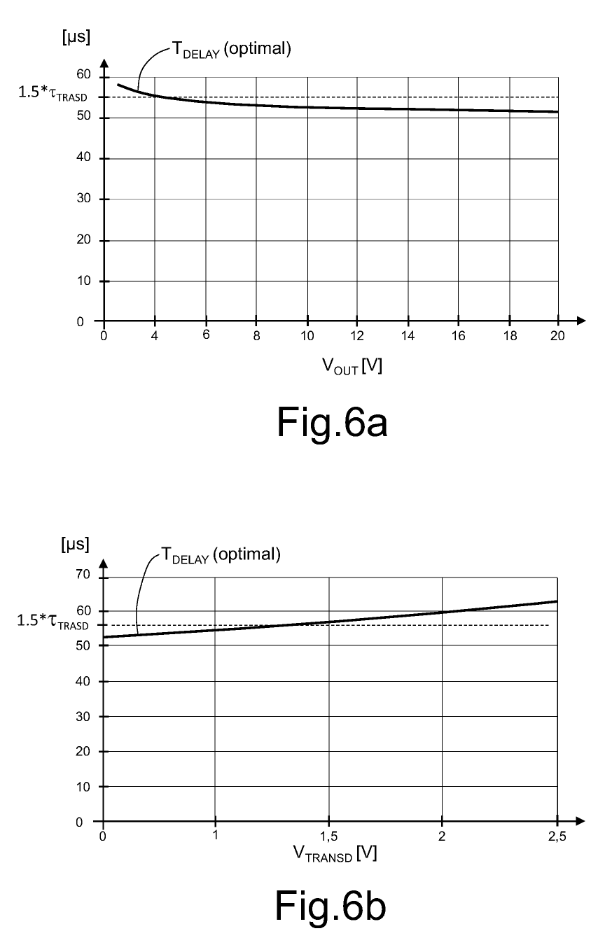

FIGS. 6a and 6b show the plots of the optimal value T_{DELAY} as the voltage on the capacitor 27/load 28 varies (FIG. 6a) and as the equivalent voltage of the transducer V_{TRANSD} and, hence, the voltage V_{IN} at input to the rectifier 24 vary (FIG. 6b).

As may be noted from FIGS. 6a and 6b, the value 1.5·τ_{TRANSD} represents an optimal compromise for all the values that V_{OUT} and V_{TRANSD} can assume (and, in use, is not known beforehand). However, if the voltages V_{OUT} and/or V_{TRANSD} are known, or in any case limited within a certain predefined interval, the constant value chosen for T_{DELAY} may differ from 1.5·τ_{TRANSD}, and possibly may also be chosen outside the interval (τ_{TRANSD}, . . . , 2·τ_{TRANSD}) so as to adapt better to the particular operating condition.

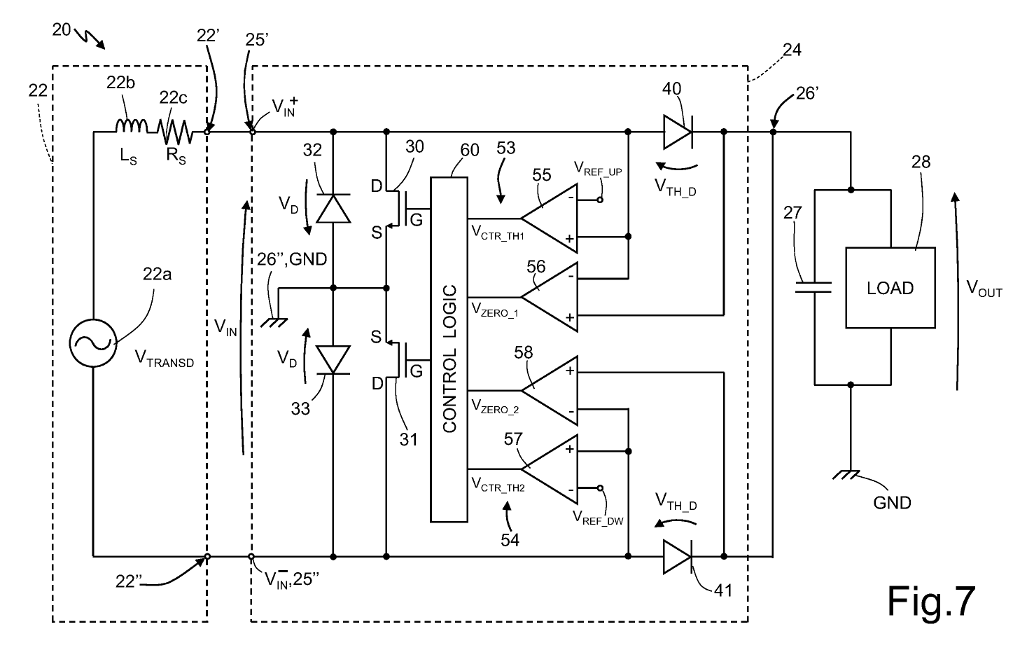

FIG. 7 shows the system of FIG. 3 comprising further electronic components adapted to control operation of the first and second transistors 30, 31.

To drive appropriately the first and second transistors 30, 31, a respective first driving circuit 53 and second driving circuit 54 are connected to the control terminal (gate terminal G) of the first transistor 30 and the second transistor 31, respectively.

The first driving circuit 53 comprises a first comparator 55 connected to the control logic 60, and a second comparator 56, which is also connected to the control logic 60. The first comparator 55 includes an inverting input terminal configured for receiving a reference signal V_{REF}_{_{—}}_{UP} and a non-inverting input terminal coupled to the anode of the third diode 40; the reference signal V_{REF}_{_{—}}_{UP} is given by I_{TH}·R_{ON}_{_{—}}_{UP}, where R_{ON}_{_{—}}_{UP} is the value of the on-state resistance of the first transistor 30. The second comparator 56 includes a non-inverting input terminal coupled to the anode of the fourth diode 40, and an inverting input terminal coupled to the cathode of the fourth diode 40.

The second driving circuit 54 comprises a third comparator 57 connected to the control logic 60, and a fourth comparator 58 connected to the control logic 60. The third comparator 57 includes an inverting input terminal configured for receiving a reference signal V_{REF}_{_{—}}_{DW} and a non-inverting input terminal coupled to the anode of the second diode 41; the reference signal V_{REF}_{_{—}}_{DW} is given by I_{TH}·R_{ON}_{_{—}}_{DW}, where R_{ON}_{_{—}}_{DW} is the value of on-state resistance of the second transistor 31. The fourth comparator 58 includes a non-inverting input terminal coupled to the anode of the second diode 41, and an inverting input terminal coupled to the cathode of the second diode 41.

In turn, the control logic 60 is coupled to the control terminals G of the first and second transistors 30, 31, for controlling operation thereof (i.e., for driving into conduction or inhibition the first and second transistors 30, 31) as described in greater detail in what follows.

In a way similar to what has been said previously, operation of the system 20 of FIG. 7 can be described with reference to the first driving circuit 53 alone, for positive polarities of the input signal V_{IN}. The operating steps of the second driving circuit 54, for negative polarities of the input signal V_{IN}, are equivalent and evident for a person skilled in the branch in the light of what has been described herein.

With reference to the first driving circuit 53, the first comparator 55 receives at input the reference voltage V_{REF}_{_{—}}_{UP} (inverting input terminal) and the voltage V_{IN} (non-inverting input terminal) and is configured for detecting, during the step of charging of the inductor 22b, according to the schematic representation of FIG. 4a, whether the current I_{ON} that flows through the first transistor 30 (and hence the current I_{L}) reaches the threshold current value I_{TH}. The control signal V_{ctr}_{_{—}}ₜₕ₁ generated at output by the first comparator 55 assumes two values, and in particular a first value indicating a value of current I_{ON} (and hence of I_{L}) lower than the threshold current value I_{TH}, and a second value indicating a value of current I_{ON} (and hence of I_{L}) equal to or higher than the threshold current value I_{TH}.

The second comparator 56 receives at input the voltage value V_{TH}_{_{—}}_{D} on the third diode 40 and is configured for detecting, during the step of discharge of the inductor 22b, according to the schematic representation of FIG. 4b, whether the current I_{OUT} that flows through the third diode 40 for supplying the capacitor 27/load 28 reaches a zero value. The control signal V_{zero 1} generated at output by the second comparator 56 is, for example, a digital signal that assumes two values, and in particular a first value indicating a current value I_{OUT} greater than zero (identifying an anode potential higher than the cathode potential of the third diode 40), and a second value indicating a current value I_{OUT} equal to zero (identifying an anode potential lower than the cathode potential of the third diode 40).

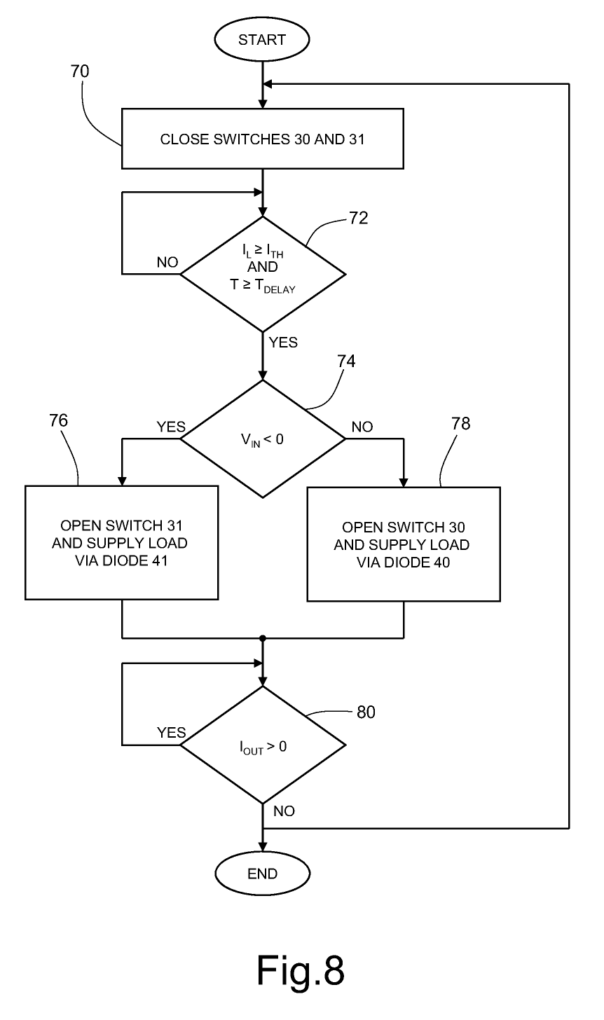

The control logic 60 implements the method for control of the first and second transistors 30, 31 described previously, and shown schematically in FIG. 8, by means of a flowchart.

With reference to FIG. 8 (step 70), the first and third transistors 30 and 31 are closed. In this way, the inductor 22b is charged via the current I_{L}=I_{ON} that flows through the first and second transistors 30, 31.

The current value I_{L}=I_{ON} is monitored (step 72) as already described with reference to FIG. 7, for detecting whether it reaches (or exceeds) the threshold value I_{TH} required. At the same time, the control logic 60 monitors the time interval T_{DELAY}. In this case, time t₀ of start of the time interval T_{DELAY} corresponds to the instant of closing of the first and second transistors 30, 31, according to step 70.

In the case where the current I_{L} has not reached the threshold I_{TH} or the time T_{DELAY} has not elapsed (output NO from step 72), it is necessary to wait for both of these conditions to be met and the control logic 60 maintains the system 20 in the states 70, 72 until both of the conditions T=T_{DELAY} and T=I_{TH} are met; otherwise (output YES from step 72), control passes to the next step 74. It is to be noted that, once the time T_{DELAY} has elapsed, if the current I_{L} has not yet reached the threshold I_{TH}, the transistors 30 and 31 are kept closed until T=I_{TH}. All the advantages referred to are in any case guaranteed.

During step 74, a check is made to see whether the input voltage V_{IN} has positive or negative polarity. This control is carried out using the comparators 55 and 57, connected, respectively, to the first input terminal 25′ and to the second input terminal 25″ of the rectifier 24, for receiving the positive half-wave V_{IN}⁺ and the negative half-wave V_{IN}⁻, respectively, of the input voltage V_{IN}.

In the case where the input voltage V_{IN} has negative polarity, control passes to step 76 (output YES from step 74), where the third switch 31 is opened, thus supplying the capacitor 27/load 28 via the second diode 41.

Instead, in the case where the input voltage V_{IN} has positive polarity, control passes to step 78 (output NO from step 74), where the first switch 30 is opened for supplying the capacitor 27/load 28 via the fourth diode 40.

Output from steps 76 and 78 leads to step 80, where the control logic 60 monitors the value of current I_{OUT} that flows through the fourth diode 40 (or the second diode 41 according to the polarity of the input voltage V_{IN}) to the output of the rectifier 24 for detecting whether the current I_{OUT} assumes a value approximately equal to zero. As long as I_{OUT}>0 A, the control logic 60 maintains the system 20 in the step of charging of the capacitor 27/supply of the load 28. When I_{OUT}=0 A, control returns to step 70. Steps 70-74 are carried out, as described with reference to FIGS. 5a-5c, in a time interval equal to T_{DELAY}, whilst steps 76-80 are carried out in a time interval equal to T_{CHARGE}.

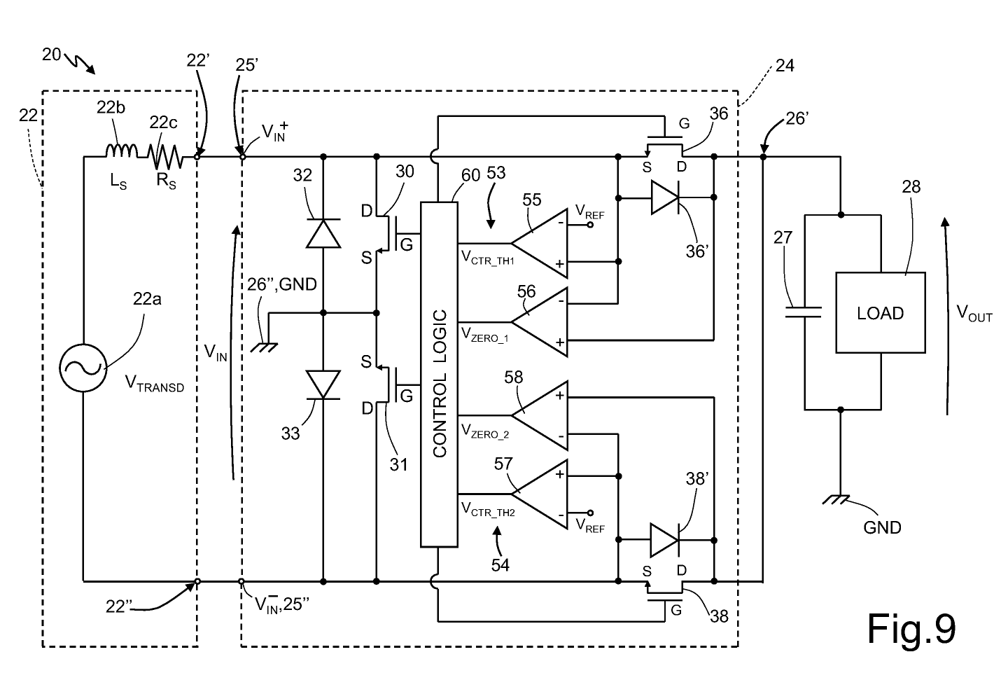

According to an alternative embodiment (shown in FIG. 9), the third and fourth diodes 40 and 41 are replaced by a respective third switch 36 and fourth switch 38, which are controlled in opening/closing by the control logic 60.

The third switch 36 is connected between the first input terminal 25′ and the first output terminal 26′ of the rectifier circuit 24, whilst the fourth switch 38 is connected between the second input terminal 25″ and the first output terminal 26′ of the rectifier circuit 24.

In a way similar to what has been said for the first and second switches 30, 31, also the third and fourth switches 31, 38 are, for example, n-type MOSFETs, shown in FIG. 9 with the respective parasitic diode 36′ and 38′ in antiparallel configuration. In what follows, the third and fourth switches 36 and 38 will be referred to as third and fourth transistors 36 and 38, without this implying any loss of generality. Also in this case, the term “transistor closed” will refer to a transistor biased so as to behave as a closed switch; and the term “transistor open” will refer to a transistor biased so as to behave as an open switch.

The source terminal S and the drain terminal D of the third transistor 36 are connected, respectively, to the first input terminal 25′ and to the first output terminal 26′ of the rectifier circuit 24; the source terminal S and the drain terminal D of the fourth transistor 38 are connected, respectively, to the second input terminal 25″ and to the first output terminal 26′ of the rectifier circuit 24.

During the steps of charging of the inductor 22b, considering an input voltage V_{IN} with positive polarity, the control logic 60 drives the first transistor 30 and the second transistor 31 into a closed state, and the third transistor 36 and the fourth transistor 38 into an open state; in this way, the situation of FIG. 4a presents, and the inductor 22b can be charged. During the steps of discharge of the inductor 22b and supply of the capacitor 27/load 28, once again considering an input voltage V_{IN} with positive polarity, the control logic 60 drives the first transistor 30 into an open state and the third transistor 36 into a closed state. In this way, the situation of FIG. 4b presents, and the capacitor 27/load 28 can be supplied.

Likewise, considering an input voltage V_{IN} with negative polarity, during the steps of charging of the inductor 22b, the control logic 60 drives the first and second transistors 30, 31 into a closed state and the third and fourth transistors 36, 38 into an open state. Instead, during the steps of discharge of the inductor 22b and supply of the capacitor 27/load 28, once again considering an input voltage V_{IN} with negative polarity, the control logic 60 drives the second transistor 31 into an open state and the fourth transistor 38 into a closed state.

By actively controlling the third and fourth transistors 36, 38 there is the advantage, as compared to the passive embodiment of FIG. 7, that the transfer of energy stored in the inductor 22b to the output (capacitor 27/load 28) is more efficient in so far as, during the transfer of energy, the voltage drop across the transistor is lower than the voltage drop across a diode.

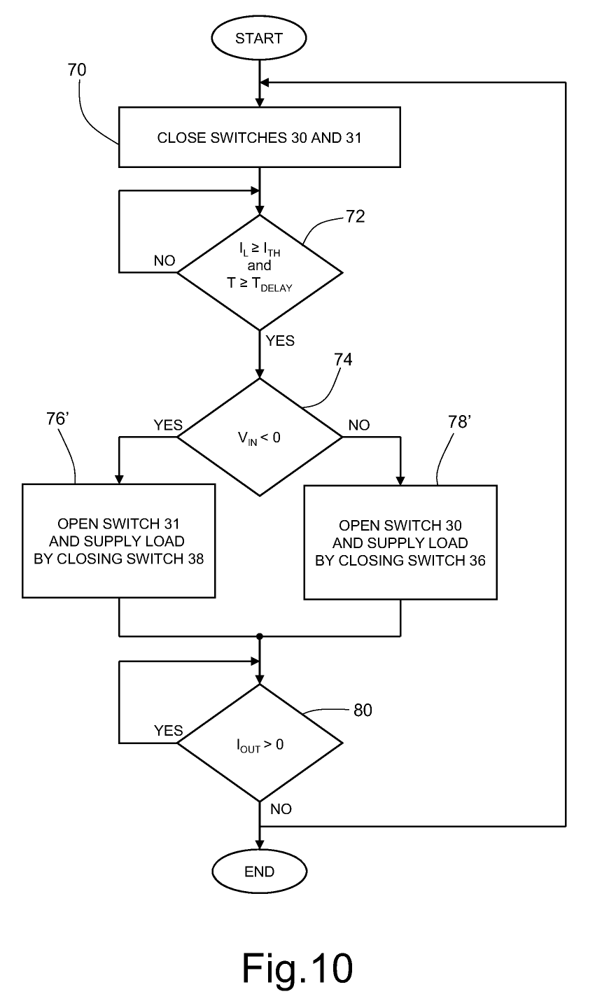

FIG. 10 shows, by means of a flowchart, the steps of a method implemented by the control logic 60 for operating the transistors 30, 31, 36, 38 of the rectifier 24 of FIG. 9.

Steps 70-74 of FIG. 10 correspond to steps 70-74 of FIG. 8 (and are for this reason designated by the same reference number and are not described any further herein).

Output YES from step 74 (input voltage V_{IN} with negative polarity) leads to step 76′. Step 76′ of FIG. 10 corresponds substantially to step 76 of FIG. 8. However, according to step 76′ of FIG. 10, the control logic 60, in addition to opening the second transistor 31, drives also the fourth transistor 38 into a closed state. The first transistor 30 remains in the closed state, and the third transistor 36 remains in the open state. The capacitor 27/load 28 are supplied by the current I_{OUT} that flows through the fourth transistor 38.

Output NO from step 74 (input voltage V_{IN} with positive polarity) leads to step 78′. Also in this case, step 78′ of FIG. 10 corresponds substantially to step 78 of FIG. 8. According to step 78′, the control logic 60 opens the first transistor 30 and closes the third transistor 36. The second transistor 31 remains in the closed state, and the fourth transistor 38 remains in the open state. Hence, the capacitor 27/load 28 are supplied by the current I_{OUT} that flows through the third transistor 36.

From steps θ and 76′ control passes to step 80, already described with reference to FIG. 8.

The control logic 60 is, for example, a microcontroller, configured for driving the first and second transistors 30 and 31 for carrying out the steps of the method of FIG. 8 (energy harvesting system 20 of FIG. 7), or for moreover driving the third and fourth transistors 36, 38, for carrying out the steps of the method of FIG. 10 (energy harvesting system 20 of FIG. 9).

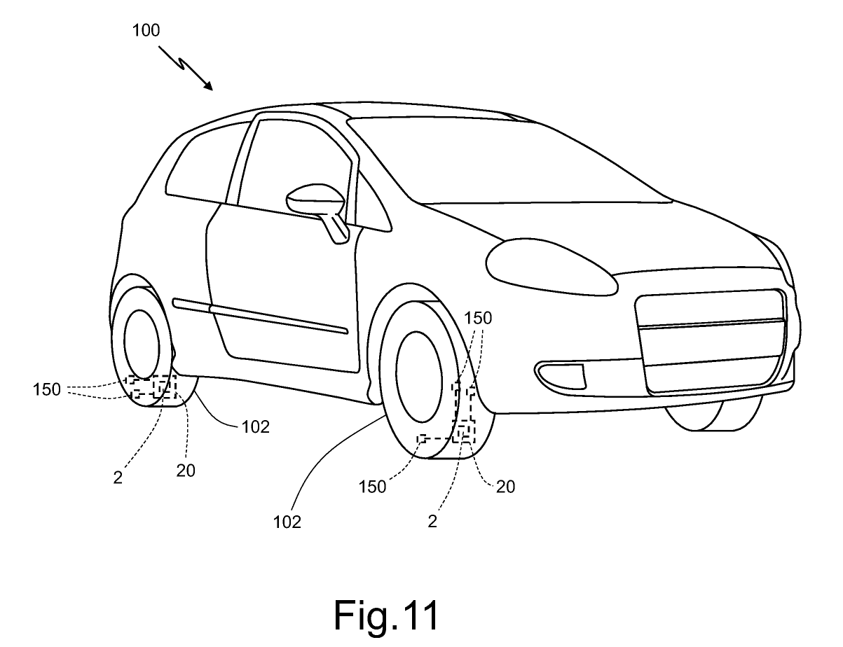

FIG. 11 shows a vehicle 100 comprising the energy harvesting system 20 of FIG. 7 or FIG. 9. The vehicle 100 is, in particular, an automobile. It is evident, however, that the energy harvesting system 20 can be used in any vehicle 100 or in systems or apparatuses other than a vehicle. In particular, the energy harvesting system 20 can find application in generic systems, in which it is desirable to harvest, store, and use environmental energy, in particular by means of conversion of mechanical energy into electrical energy.

With reference to FIG. 11, the vehicle 100 comprises one or more transducers 2 coupled in a known way to a portion of the vehicle 100 subject to mechanical stresses and/or vibrations, for converting said mechanical stresses and/or vibrations into electric current.

The energy harvesting system 20 is connected to one or more electrical loads 28a, . . . , 28n, for example via interposition of a DC-DC converter. In particular, according to one application, the electrical loads 28a, . . . , 28n comprise TPM (tire-parameter monitoring) sensors 150 for monitoring parameters of tires 102. In this case, the TPM sensors 150 are coupled to an internal portion of the tires 102 of the vehicle 100. Likewise, also the transducers 2 (for example, of an electromagnetic or piezoelectric type) are coupled to an internal portion of the tires 102. The stress of the transducers 2 when the vehicle 100 is travelling causes production of an electric current/voltage signal at output from the transducer 2 by means of conversion of mechanical energy into electrical energy. The electrical energy thus produced is stored, as described previously, in the storage element 27 and supplied, via the DC-DC converter that may be present, to the TPM sensors 150.

According to one embodiment, the energy harvesting system 20, comprising one or more transducers, and the TPM sensors 150, are glued within one or more tires 102. The impact of the tires 102 on the ground during motion of the vehicle 100 enables production of electrical energy.

As an alternative to what is shown in FIG. 11, the energy harvesting system 20 can be set in any other portion of the vehicle 100 and/or used for supplying an electrical load different from or in addition to the TPM sensors 150.

Another possible application of the energy harvesting system 20 is the generation of electrical energy by exploiting the mechanical energy produced by an individual when he is walking or running In this case, the energy harvesting system 20 is located inside the shoes of said individual (for example, inside the sole). In systems aimed at fitness, where it is particularly interesting to count the steps, it is useful to recover energy from the vibrations induced by walking/running to be able to supply, without using a battery, acceleration sensors and/or RFID transmitters capable of communicating with cellphones, music-playing devices, or any other apparatus involved in information on the steps performed.

From an examination of the characteristics obtained according to the present disclosure the advantages that it affords are evident.

In particular, since the duration of the time interval T_{DELAY} is (typically) constant, the rectifier 24 operates at constant duty cycle of the signal of opening/closing of the first and second switches 30, 31; this enables efficiency values η_{SCAV} (efficiency of the rectifier 24, having the function of scavenging interface of the system 20) comprised between 70% and 85% to be obtained. With reference to FIG. 11, the efficiency values η_{SCAV} indicated are substantially independent of the speed of rotation of the tires 102 and of the conditions of storage of the energy so as to satisfy the requirements of the TPM sensors 150.

The HV technology used for the capacitor 27 and for the scavenging interface enables storage of high voltages, and hence high energy, in the capacitor 27, consequently increasing the autonomy of operation of the TPM sensors 150.

Furthermore, as has been said, the value of the interval T_{DELAY} can be varied according to the particular application in which the rectifier circuit 24 operates. The rectifier 24 then finds use in systems different from the energy harvesting system 20, based upon electromagnetic transducers of any type.

Furthermore, the rectifier circuit 24 can be used with transducers of another type, by means of interposition of an appropriate circuit between the transducer and the rectifier circuit adapted to provide an energy accumulator similar to the inductor 22b.

Furthermore, the rectifier circuit 24 and the energy harvesting system 20 are of a completely integrated type, and consequently require minimum space for installation.

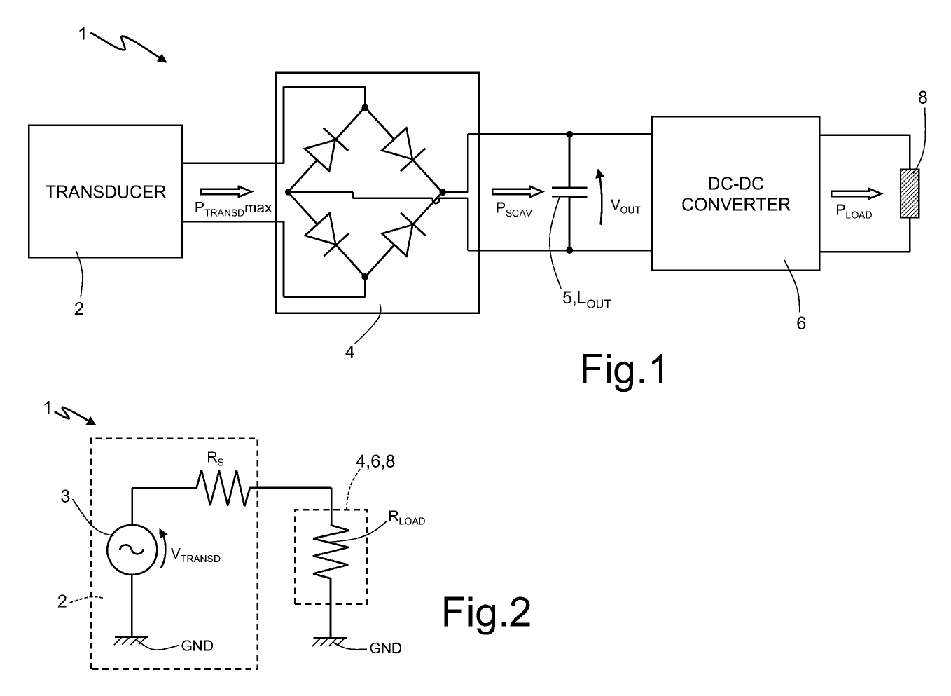

Finally, recovery of environmental energy occurs also when the signal of the transducer is lower than the voltage value accumulated on the output capacitor, which is not possible using a diode-bridge interface of a known type, as shown in FIG. 1. Accordingly, the scavenging interface 24 is hence able to recover energy also when the power supplied by the transducer is very low.

Finally, it is clear that modifications and variations may be made to what has been described and illustrated herein, without thereby departing from the sphere of protection of the present invention, as defined in the annexed claims.

In particular, according to one embodiment, the rectifier circuit 24 can comprise a number of transistors/diodes different from the one described. For example, the rectifier circuit 24 can be a half-wave rectifier, comprising just two transistors, for example just the transistors 30 and 36, or else just the transistors 31 and 38, or else comprising the first transistor 30 and the diode 40, or the second transistor 31 and the diode 41. Use of a half-wave rectifier can be advantageous in the case where the input signal V_{IN} is of a known type and comprises only positive (or negative) half-waves. Its use is, however, not recommended if the input signal has a positive or negative polarity.

In addition, there may be present a plurality of transducers 2, all of the same type or of a type different from one another, indifferently. For example, the transducer/transducers can be chosen in the group comprising: electrochemical transducers (adapted to convert chemical energy into an electrical signal), electromechanical transducers (adapted to convert mechanical energy into an electrical signal), electroacoustic transducers (adapted to convert variations of pressure into an electrical signal), electromagnetic transducers (adapted to convert a magnetic field into an electrical signal), photoelectric transducers (adapted to convert light energy into an electrical signal), electrostatic transducers, thermoelectrical transducers, piezoelectric transducers, thermoacoustic transducers, thermomagnetic transducers, or thermoionic transducers.

What is claimed is:

1. Apparatus, comprising:
an energy-scavenging interface having a first input terminal and a second input terminal configured for connection to a transducer which includes a storage element producing an electrical input signal having a first polarity and a second polarity of opposite sign with respect to one another, and further having a first output terminal and a second output terminal configured for connection to an electrical load to supply an output signal, the energy-scavenging interface comprising:
a first switch connected between the first input terminal and the second output terminal;
a first current-conduction element connected between the first input terminal and the first output terminal; and
control logic configured to:
drive, when the electrical input signal has the first polarity, the first switch to a closed state for a first time interval having at least one first temporal duration proportional to a time constant of the transducer and until electrical energy accumulated by the storage element reaches a first threshold value; and
drive the first switch to an open state for a second time interval having a second temporal duration subsequent to the first time interval so as to supply electrical charge accumulated in the storage element towards the electrical load through the first current-conduction element.

2. The apparatus of claim 1 wherein the energy-scavenging interface further comprises:
a second switch connected between the second input terminal and the second output terminal; and
a second current-conduction element connected between the second input terminal and the first output terminal,
wherein the control logic is further configured to:
drive, when the electrical input signal has the first polarity, the second switch to a closed state.

3. The apparatus of claim 1 wherein the energy-scavenging interface further comprises:
a second switch connected between the second input terminal and the second output terminal; and
a second current-conduction element connected between the second input terminal and the first output terminal,
wherein the control logic is further configured to:
drive, when the electrical input signal has the second polarity, the second switch to a closed state for a third time interval having at least the first temporal duration and until the electrical energy accumulated by the storage element reaches the first threshold value; and
drive the second switch to an open state for a fourth time interval having the second temporal duration so as to supply electrical charge accumulated in the storage element towards the electrical load through the second current-conduction element.

4. The apparatus of claim 1, wherein the transducer is an electromagnetic transducer having an equivalent value of inductance and an equivalent value of resistance, said time constant being given by the ratio between the equivalent value of inductance and the equivalent value of resistance.

5. The apparatus of claim 1, wherein said first temporal duration has a constant value.

6. The apparatus of claim 5, wherein said first temporal duration is equal to approximately 1.5 times the time constant of the transducer.

7. The apparatus of claim 3, wherein the energy-scavenging interface further comprises a first electrical-signal detecting device configured to compare the electrical input signal to a first reference signal and generate a first control signal indicative of whether the energy accumulated by the storage element during the first time interval has reached the first threshold value.

8. The apparatus of claim 7, wherein the energy-scavenging interface further comprises a second electrical-signal detecting device configured to compare the electrical input signal acquired to a second reference signal and generate a second control signal indicative of whether the energy accumulated by the storage element during the first time interval reaches the first threshold value.

9. The apparatus of claim 8, wherein the energy-scavenging interface further comprises a third electrical-signal detecting device configured to detect, during the second time interval, a first value of output current flowing through the first current-conduction element, and wherein the control logic is further configured to drive, when the electrical input signal has the first polarity, the first switch to the closed state if the first value of output current is approximately zero and drive, when the electrical input signal has the first polarity, the first switch to the open state if the first value of output current is greater than zero.

10. The apparatus of claim 9, wherein the energy-scavenging interface further comprises a fourth electrical-signal detecting device configured to detect, during the fourth time interval, a second value of output current flowing through the second current-conduction element, and wherein the control logic is further configured to drive, when the electrical input signal has the second polarity, the first and third switches into the closed state if the second value of output current is approximately zero, and drive, when the electrical input signal has the second polarity, the second switch into the open state if the second value of output current is greater than zero.

11. The apparatus of claim 1, wherein the first current-conduction element is a controlled switch, said control logic further configured to close the first current-conduction element during the second time interval and open the first current-conduction element during the first time interval.

12. The apparatus of claim 3, wherein the second current-conduction element is a controlled switch, said control logic further configured to close the second current-conduction element during the fourth time interval and open the second current-conduction element during the third time interval.

13. The apparatus of claim 1, further comprising:
a transducer configured to convert energy coming from an external source of energy to an AC electrical signal for application to the first and second input terminals; and
a first storage element coupled to the first and second output terminals and configured to accumulate electrical energy for supply to an electrical load.

14. The apparatus of claim 13, further comprising a DC-DC converter coupled between the first storage element and the electrical load.

15. The apparatus according to claim 14, wherein the transducer is coupled to a selected one of a vehicle and an item of sports footwear.

16. A method for scavenging energy using an energy-scavenging interface having a first input terminal and a second input terminal, connectable to a transducer including a storage element, and a first output terminal and a second output terminal, connectable to an electrical load, wherein the first and second input terminals are configured to receive an electrical input signal having a first polarity and a second polarity of opposite sign with respect to one another, generated by the transducer, and the first and second output terminals are configured to supply to the electrical load an output signal, the method comprising the steps of:
storing electrical charge in the storage element during a first time interval;
driving, when the electrical input signal has the first polarity, a first switch connected between the first input terminal and the second output terminal to a closed state for the first time interval having at least one first temporal duration proportional to a time constant of the transducer and until the electrical charge accumulated by the storage element reaches a threshold value;
driving the first switch to an open state for a second time interval, having a second temporal duration, subsequent to the first time interval; and
supplying charge accumulated in the storage element through a first current-conduction element connected between the first input terminal and the first output terminal as the output signal to the electrical load during the second time interval.

17. The energy-scavenging method according to claim 16, further comprising the steps of:
receiving, by means of a second switch (31) connected between the second input terminal (25″) and the second output terminal (26″), the signal function of the electrical input signal (V_{IN}, I_{L});
driving, when the electrical input signal has the first polarity, the second switch to a closed state;
driving, when the electrical input signal has the second polarity, the first switch and the second switch to a closed state for a third time interval having at least the first temporal duration in which the storage element stores electrical charge and until the electrical charge accumulated by the storage element reaches the threshold value (I_{TH});
driving the second switch to an open state for a fourth time interval having the second temporal duration; and
supplying electrical charge accumulated in the storage element through a second current-conduction element connected between the second input terminal and the first output terminal as the output signal to the electrical load during the fourth time interval.

18. The energy-scavenging method according to claim 16, wherein the transducer is an electromagnetic transducer having an equivalent value of inductance and an equivalent value of resistance, said time constant being given by the ratio between the equivalent value of inductance and the equivalent value of resistance.

19. The energy-scavenging method according to claim 16, wherein said first temporal duration has a constant value.

20. The energy-scavenging method according to claim 19, wherein said first temporal duration is equal to approximately 1.5 times the time constant of the transducer.

21. The energy-scavenging method according to claim 16, further comprising the steps of:
detecting, during the second time interval, a first value of output current that flows between the first input terminal and the first output terminal through the first current-conduction element;
driving, when the electrical input signal has the first polarity, the first switch into the closed state if the first value of output current is approximately zero; and
driving, when the electrical input signal has the first polarity, the first switch into the open state if the first value of output current is greater than zero.

22. The energy-scavenging method according to claim 17, further comprising the steps of:
detecting, during the fourth time interval, a second value of output current that flows between the second input terminal and the first output terminal through the second current-conduction element;
driving, when the electrical input signal has the second polarity, the first and third switches into the closed state if the second value of output current is approximately zero; and
driving, when the electrical input signal has the second polarity, the second switch into the open state if the second value of output current is greater than zero.

23. The energy-scavenging method according claim 16, wherein the first current-conduction element is a controlled switch, the method further comprising the steps of closing the first current-conduction element during the second time interval and opening the first current-conduction element during the first time interval.

24. The energy-scavenging method according to claim 17, wherein the second current-conduction element is a controlled switch, the method further comprising the steps of closing the second current-conduction element during the fourth time interval and opening the second current-conduction element during the third time interval.

25. Apparatus, comprising:
an input node configured to receive an electrical signal generated by a transducer having a charge storage element;
an output node;
a reference node;
a first transistor coupled between the input node and the reference node;
a first conduction element coupled between the input node and the output node;
a first circuit configured to sense current flow through the first transistor;
a second circuit configured to sense current flow through the first conduction element; and
a control circuit configured to control actuation of the first transistor in response to outputs produced by the first and second circuits, said control circuit operable to close the first transistor so as to store charge in the charge storage element until said first circuit output indicates sensed current flow through the first transistor has reached a first threshold and thereafter open the first transistor so as to deliver stored charge to the output node until said second circuit output indicates sensed current flow through the first conduction element has reaches a second threshold.

26. The apparatus of claim 25, wherein the first threshold corresponds to said stored charge in the charge storage element reaching a level and the second threshold is at or approximately zero.

27. The apparatus of claim 25, wherein the first conduction element is a second transistor coupled between the input node and the output node, and wherein the control circuit is configured to control actuation of the first and second transistors in response to outputs produced by the first and second circuits, said control circuit operable to open the second transistor when the first transistor is closed and close the second transistor when the first transistor is open.

28. The apparatus of claim 25, further comprising:
the transducer configured to convert energy coming from an external source of energy to generate the electrical signal for application to the input node; and
an additional charge storage element coupled between the output node and the reference node.

29. The apparatus of claim 28, further comprising a DC-DC converter coupled between the additional storage element and an electrical load output node.

30. A method, comprising:
(a) actuating a first transistor to pass current and store electrical energy in a charge storage element of a transducer;
(b) sensing current flow through the first transistor;
(c) deactuating the first transistor when sensed current flow through the first transistor reaches a first threshold;
(d) thereafter delivering stored electrical energy from the charge storage element to an output through a first conduction element;
(e) sensing current flow through the first conduction element;
(f) returning to step (a) when sensed current flow through the first conduction element reaches a second threshold.

31. The method of claim 30, wherein the first threshold corresponds to said stored charge in the charge storage element reaching a level and the second threshold is at or approximately zero.

32. The method of claim 30, wherein the first conduction element is a second transistor, and wherein step (a) further comprises deactuating the second transistor, and wherein step (c) further comprises actuating the second transistor.
